(19) United States
(12) Patent Application Publication
(10) Pub. No.: US 2003/0198925 A1
(43) Pub. Date: Oct. 23, 2003

(54) Shaken baby syndrome educational apparatus

(76) Inventor: Stephanie Dowell, Bayport, NY (US)

Correspondence Address: Michael S. Neustel, Suite No. 4, 2534 South University Drive, Fargo, ND, 58103, US

(21) Appl. No.: 10/128,732

(22) Filed: Apr. 22, 2002

(51) Int. Cl. G09B 23/28

(52) U.S. Cl. 434/262

(57) ABSTRACT

A shaken baby syndrome educational apparatus for educating individuals regarding shaken baby syndrome. The shaken baby syndrome educational apparatus includes a housing having a head portion and a neck portion. Internal to the head section and neck section is a simulated brain and spinal cord with vertebrae attached to the housing that can move freely within the head and neck section. Attached to the interior walls of the head and neck section are a plurality of pressure sensors. The pressure sensors are connected to a central processing unit. Attached to the exterior walls of the head and neck section are a plurality of indicator lights. The indicator lights are connected to the central processing unit. When the housing is shaken the brain and spinal cord with vertebrae can tilt back and forth making contact with the pressure sensors. The pressure sensors then send a signal to the central processing unit which in turn sends a signal illuminating the indicator lights. The central processing unit has a reset set switch to terminate the illumination signal to the indicator lights.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to shaken baby syndrome education and more specifically it relates to a shaken baby syndrome educational apparatus for educating individuals regarding shaken baby syndrome.

2. Description of the Prior Art

Educational prevention products have been in use for years. Typically, educational prevention products for shaken baby syndrome include videos handouts, posters, and teaching curriculum. These materials describe what happens when a baby is violently shaken. These materials present illustrated representations of the movement of the brain during the shaking of an infant. For the most part these educational prevention products require the individual to visualize what occurs internally to a baby when a baby is violently shaken. Current life-like infant dolls and stuffed toy animals are used to show the movement of the head in opposite and direct contrast to the movement of the body of the infant. These instructional devices do not sufficiently demonstrate the significant damage that can be caused by shaking an infant. In the case of current infant dolls, they fail to demonstrate the physics associated with the internal trauma resulting from the brains movement within the skull when an infant is violently shaken.

It is also well known in the art to construct dolls with one or more life-like characteristics for educational purposes. Dolls are presently available which are capable of being used in the instruction of cardiopulmonary resuscitation, the location of internal organs, toilet training and various other instructional purposes.

While these devices may be suitable for the particular purpose to which they address, they are not as suitable for educating individuals regarding shaken baby syndrome. No current shaken baby syndrome educational device accurately portrays how the brain moves within the skull when an infant is shaken. No current educational devise provides a visual display of the brain striking the internal walls of the skull. No current educational devise shows the interaction of the spinal cord and vertebrae with the brain when an infant is violently shaken.

In these respects, the shaken baby syndrome educational apparatus according to the present invention substantially departs from the conventional concepts and designs of the prior art, and in so doing provides an apparatus primarily developed for the purpose of educating individuals regarding shaken baby syndrome by demonstrating the movement of the brain in the skull and the interaction of the spinal cord and vertebrae with the movement of the brain.

### SUMMARY OF THE INVENTION

In view of the foregoing disadvantages inherent in the known types of shaken baby syndrome educational materials now present in the prior art, the present invention provides a new shaken baby syndrome educational apparatus construction wherein the same can be utilized for educating individuals regarding shaken baby syndrome.

The general purpose of the present invention, which will be described subsequently in greater detail, is to provide a new shaken baby syndrome educational apparatus that has many of the advantages of the educational materials mentioned heretofore and many novel features that result in a new shaken baby syndrome educational apparatus which is not anticipated, rendered obvious, suggested, or even implied by any of the prior art, either alone or in any combination thereof.

To attain this, the present invention generally comprises an apparatus having a hollow skull and neck portion in which a simulated brain and spinal cord with vertebrae are located in their proper perspective. The primary purpose of the shaken baby syndrome educational apparatus is education to provide parents, educators, childcare providers and young children with knowledge as to the serious consequences of shaking an infant. Such a tangible visual aid is most helpful in explaining how that during the shaking of an infant the brain moves within the skull, how the spinal cord and vertebrae are impacted by that movement, and how that movement is detrimental to an infant.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a shaken baby syndrome educational apparatus that will overcome the shortcomings of the prior art devices.

A second object is to provide a shaken baby syndrome educational apparatus for educating one or more individuals simultaneously regarding shaken baby syndrome.

Another object is to provide a shaken baby syndrome educational apparatus that allows individuals to view the movement of the brain within the skull during the shaking of an infant.

Another object is to provide a shaken baby syndrome educational apparatus that visually indicates the specific locations of impact of the brain with the skull during a shaking incident.

Another object is to provide a shaken baby syndrome educational apparatus that allows individuals to view the movement of the spinal cord in relation to the movement of the brain during the shaking of an infant.

Another object is to provide a shaken baby syndrome educational apparatus that allows for demonstration that the spinal cord, vertebrae and neck muscles cannot fully support and control the head while being shaken back and forth.

Another object is to provide a shaken baby syndrome educational apparatus that can simulate the relative severity of injury based on how severe the educational apparatus is shaken.

Another object is to provide a shaken baby syndrome educational apparatus that can assist experts and witnesses in providing testimony concerning shaken baby syndrome in criminal and civil cases.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the present invention.

FIG. 2 is a side cutaway view of the present invention with the simulated brain and spinal cord in their normal position.

FIG. 3 is a side cutaway view of the present invention with the simulated brain in contact with the front of the skull.

FIG. 4 is a side cutaway view of the present invention with the simulated brain in contact with the back of the skull.

FIG. 5 is a block diagram illustrating the electrical components of the present invention.

### DESCRIPTION OF THE PREFERRED EMBODIMENT

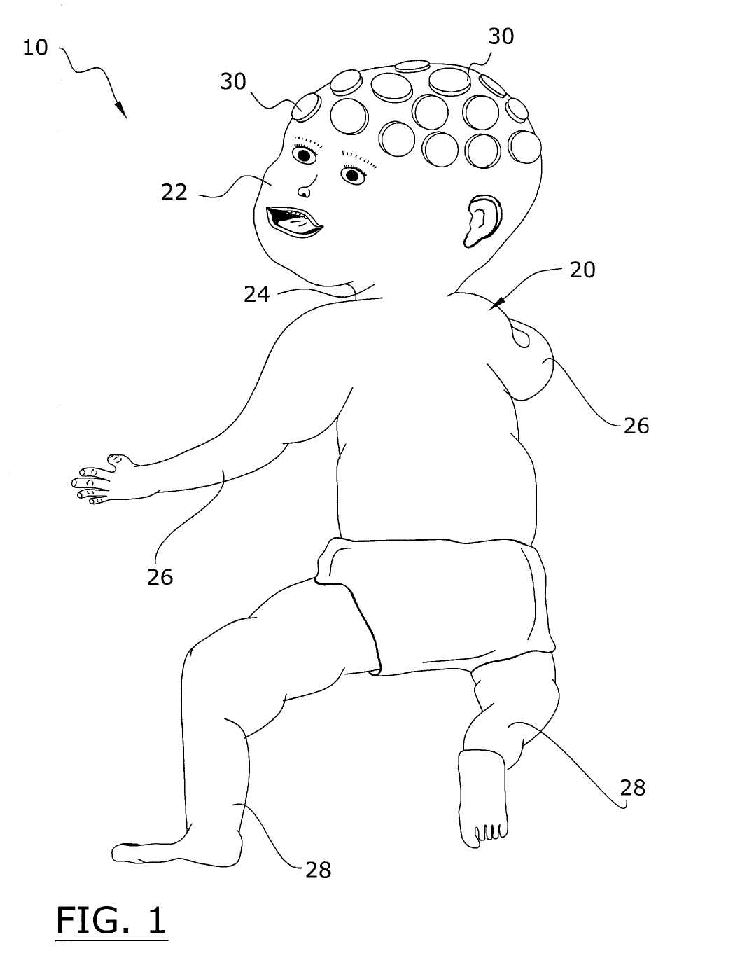

Turning now descriptively to the drawings, in which similar reference characters denote similar elements throughout the several views, FIGS. 1 through 5 illustrate a shaken baby syndrome educational apparatus, which comprises an infant-shaped housing 20 with a hollow head 22 and hollow neck section 24. Internal to the head 22 and neck section 24 is a simulated brain 72 and spinal cord with vertebrae 76 that can freely move within the hollow head 22 and neck section 24. The brain 72 and spinal cord with vertebrae 76 are preferably made from rubber or any other suitable resilient material to keep the brain 22 and spinal cord with vertebrae 24 in a normal position. The brain 22 and spinal cord with vertebrae 24 are attached to the lower portion of the infant-shaped housing 20. Attached to the interior walls of the head 22 and neck section 24 are a plurality of pressure sensors 40, and attached exterior to the walls of the head 22 and neck section 24 are a plurality of indicator lights 30.

As best illustrated in FIG. 1, the housing 20 is preferably constructed in the shape of a small infant. The housing 20 preferably includes arms 26 and legs 28 proportional to the housing 20 to give the housing 20 the overall appearance and feel of an infant. The housing 20 may be constructed from pliable material at a specified thickness to provide the flexible feel of an infant's body. The pliable material used in constructing the housing 20 may be manufactured in human skin tones or various other designs.

The housing 20 is preferably weighted and sized to approximate the weight and size of an infant. The weight of the housing 20 is preferably between 5 and 50 pounds and the size is preferably between 12 and 36 inches. However, it can be appreciated by one skilled in the art that other embodiments of the present invention may include housings 20 to simulate infants at varying sizes and weights.

The hollow head 22 and neck section 24 may be made of transparent or semi-transparent material to permit visual observation of the brain 72 and spinal cord with vertebrae 76. The transparent or semi-transparent material should be manufactured of sufficient strength to withstand repeated impacts from the brain 72 and spinal cord with vertebrae 76. As shown in FIG. 1 the head 22 may include the facial features of an infant.

The physical dimensions of the brain 72 and spinal cord with vertebrae 76 are preferably manufactured to the corresponding size and weight of an infant's brain and spinal cord with vertebrae. However, it can be appreciated by one skilled in the art that other embodiments of the present invention may include brains 72 and spinal cord with vertebras 76 of varying sizes and weights. The brain 72 and spinal cord with vertebrae 76 may be formed to have the physical appearance of an infant brain and spinal cord with vertebrae. The spinal cord with vertebrae 76 is attached to the housing 20 in such a way that the brain 72 and spinal cord with vertebrae 76 can move freely within the hollow head 22 and neck section 24.

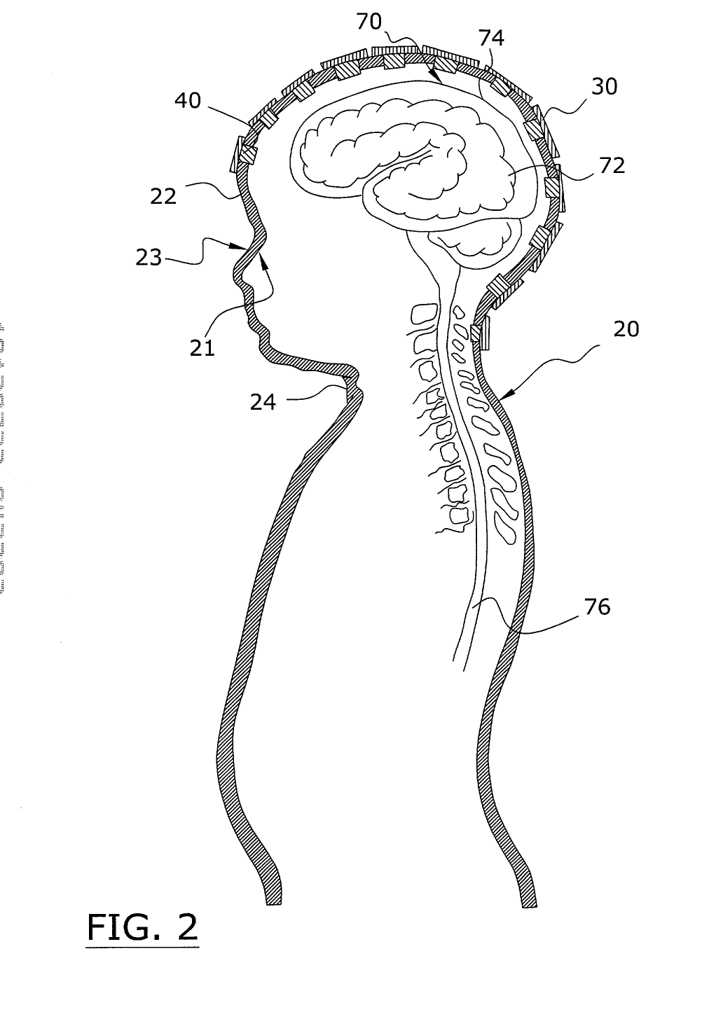

As best seen in FIG. 2, the hollow head 22 and neck section 24 have an inner wall 21. Attached to the inner wall 21 is a plurality of pressure sensors 40. The pressure sensors 40 are attached to the inner wall 21 starting at the inner wall 21 opposite the housing's 20 forehead location and located throughout the inner circumference of the head 22 and neck section 24 ending at a location opposite the base of the neck section 24. Each pressure sensor 40 is electrically connected to the central processing unit 50.

As best seen in FIGS. 1 and 2, the hollow head 22 and neck section 24 have an outer wall 23. Attached to the outer wall 23 is a plurality of indicator lights 30. The indicator lights 30 are attached to the outer wall 23 starting at the outer wall 23 opposite the housing's 20 forehead location and located throughout the outer circumference of the of the head 22 and neck section 24 ending at a location opposite the base of the neck section 24. Each indicator light 30 is electrically connected to the central processing unit 50. The indicator lights 30 are preferably located opposite each pressure sensor 40 to illuminate when the corresponding pressure sensor 40 is engaged.

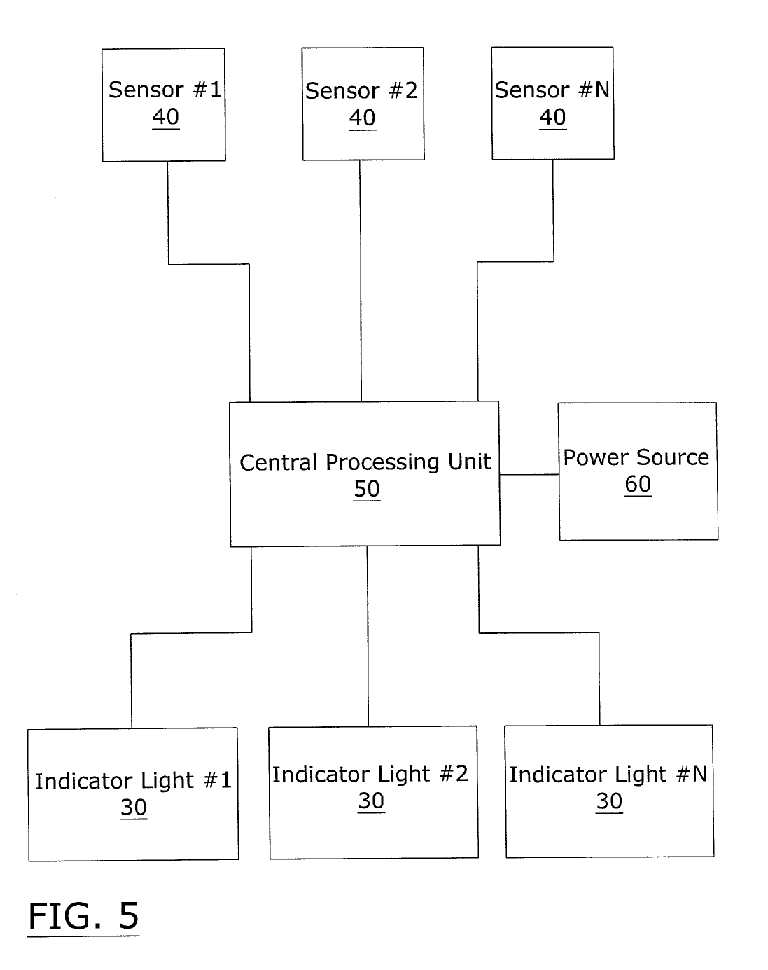

As best seen in FIG. 5, the central processing unit 50 has a power source 60. When pressure is applied to a pressure sensor 40 a signal is sent to the central processing unit 50. The central processing unit 50 then sends a signal to illuminate the indicator light 30 located opposite the pressure sensor 40 that was activated. The central processing unit 50 will have a reset mode to terminate the illumination signal to the indicator lights 30 that are illuminated.

As best seen in FIG. 2, the simulated brain 72 and spinal cord with vertebrae 76 are situated in the hollow head 22 and neck section 24 to demonstrate the location of the brain and spinal cord in an infant during its normal position. When the shaken baby syndrome apparatus's brain 22 and spinal cord 24 section are in this normal position they are not in contact with any of the pressure sensors 40 on the interior wall of the head 22 and neck section 24. None of the indicator lights 30 are illuminated in this normal position.

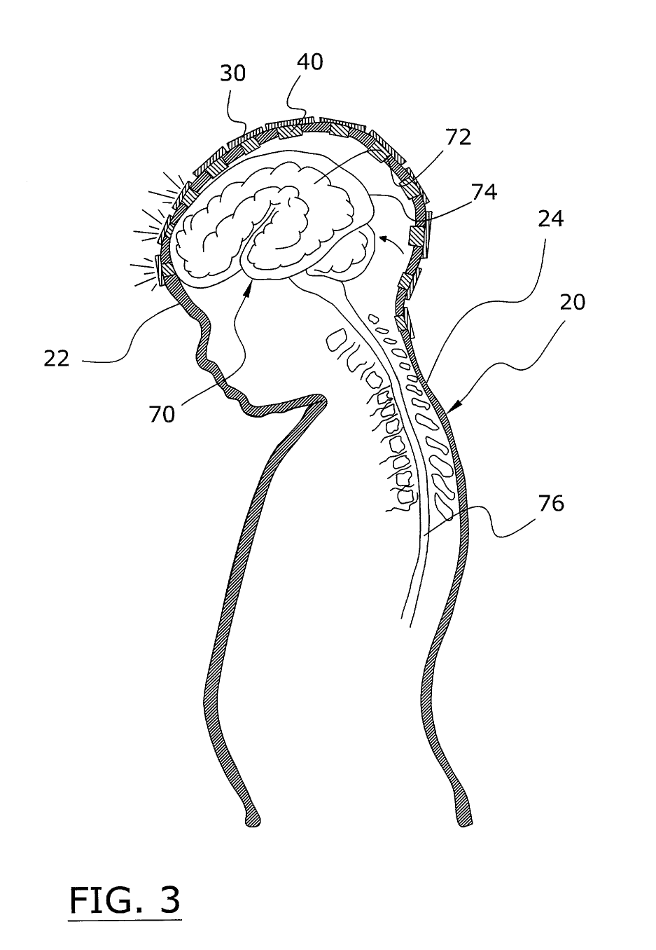

As best seen in FIG. 3 when the shaken baby syndrome apparatus is shaken in a direction opposite the front of the housing 20 the head 22 and neck section 24 will initially tilt towards the front of the housing 20. When the rearward shaking movement is stopped the head 22 and neck section 24 will tilt towards the back of the housing 20 and the brain 72 and spinal cord with vertebrae 76 will flex towards the rear of the head 22 and neck section 24. When the housing 20 is shaken with sufficient momentum the brain 72 and neck section 76 will impact pressure sensors 40 located on the rear interior wall of the head 22 and neck section 24. The pressure sensors 40 will send a signal to the central processing unit 50 which will in turn send a signal to the indicator lights 30 opposite the impacted pressure sensors 40 causing the indicator lights 30 to illuminate.

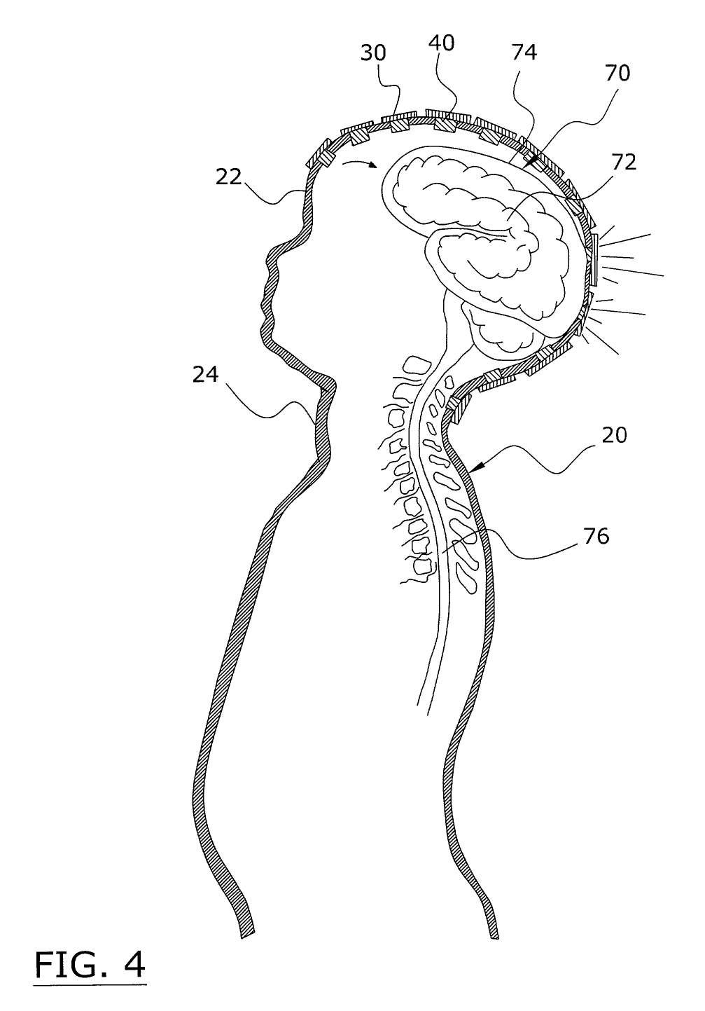

As best seen in FIG. 4 when the shaken baby syndrome apparatus is shaken in a direction opposite the back of the housing 20 the head 22 and neck section 24 will initially tilt towards the back of the housing 20. When the forward shaking movement is stopped the head 22 and neck section 24 will tilt toward the front of the housing 20 and the brain 72 and neck section 76 will flex towards the front of the head 22 and neck section 24. When the housing 20 is shaken with sufficient momentum the brain 72 and neck section 76 will impact pressure sensors 40 located on the front interior wall 21 of the head 22 section. The pressure sensors 40 will send a signal to the central processing unit 50 which will in turn send a signal to the indicator lights 30 opposite the impacted pressure sensors 40 causing the indicator lights 30 to illuminate. The more violently the housing 20 is shaken, the more pressure sensors 40 will be contacted and the greater number of indicator lights 30 will illuminate.

While the above description contains many specificities, these should not be construed as limitations on the scope of the invention, but rather as an exemplification of one preferred embodiment thereof. Many other variations are possible. For example, the pressure sensors 40, indicator lights 30, central processing unit 50, and power source 60 could be removed. This embodiment would use a transparent head 22 and neck section 24 so that the movement of the brain 72 and neck section with vertebrae 76 could be visually observed. Another embodiment could use only a hollow head 22 sections and not a hollow neck 24 section. This embodiment could include a brain 72 section which is not attached to the housing 20.

In use, an individual would demonstrate the movement of the brain and spinal cord in a real infant by grabbing the infant-shaped housing 20 and shaking it back and forth. As the housing 20 is shaken in a direction opposite the front of the housing 20 the head 22 and neck section 24 will initially tilt towards the front of the housing 20. When the rearward shaking motion is stopped the head 22 and neck section 24 will tilt towards the back of the housing 20 and the brain 72 and spinal cord with vertebrae will flex towards the rear of the head 22 and neck section 24. As the shaking movement direction is changed the housing 20 will move in the direction opposite the back of the housing 20. The head 22 and neck section 24 will continue to tilt towards the back of the housing 20. When the forward motion is stopped the head 22 and neck section 24 will tilt towards the front of the housing 20 and the brain 72 and spinal cord section with vertebrae 76 will tilt towards the front of the housing. As the motion is repeated with more momentum the brain 72 and spinal cord with vertebrae 76 will move further within the head 22 and neck section 24 contacting the pressure sensors 40. The pressure sensors 40 will illuminate the corresponding indicator lights 30. As the shaking becomes more violent the brain 72 and neck section 76 will tilt further and further striking the interior wall 21 and pressure sensors 40 with greater force. Supplemental materials may be provided with the sudden infant death syndrome apparatus to describe the internal damages caused by different sensors being illuminated.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A shaken baby syndrome educational apparatus, comprising:
a housing;
a head portion and neck portion each having an interior wall and an exterior wall;
a simulated brain attached to said interior wall;
a plurality of pressure sensors attached to said interior wall;
a plurality of light indicators attached to said exterior wall; and
a central processing unit in communication with said pressure sensors and said indicator lights, wherein said central processing unit is operative to measure a pressure exerted upon each of said pressure sensors.

2. The shaken baby syndrome educational apparatus of claim 1, wherein said housing has a structure similar to an infant.

3. The shaken baby syndrome educational apparatus of claim 1, wherein said housing has a weight between 6 pounds to 50 pounds.

4. The shaken baby syndrome educational apparatus of claim 1, wherein said housing is between 12 inches and 36 inches in length.

5. The shaken baby syndrome educational apparatus of claim 1, wherein said housing is made from a pliable material at a thickness to simulate the feel of an infant's body.

6. The shaken baby syndrome educational apparatus of claim 1, wherein said housing is made from a material manufactured in human skin tones.

7. The shaken baby syndrome educational apparatus of claim 1, wherein said brain has the physical characteristics of an infant's brain.

8. The shaken baby syndrome educational apparatus of claim 1, including a spinal cord with vertebrae attached between said brain and said interior wall.

9. The shaken baby syndrome educational apparatus of claim 1, wherein said spinal cord and vertebrae section have the physical characteristics of an infant's spinal cord and neck section.

10. The shaken baby syndrome educational apparatus of claim 1, wherein said head and neck portion is translucent.

11. The shaken baby syndrome educational apparatus of claim 1, wherein said brain is made of a gel material.

12. The shaken baby syndrome educational apparatus of claim 1, wherein said apparatus includes a booklet describing the physiology surrounding shaken baby syndrome.

13. A method of educating individuals regarding shaken baby syndrome, said method comprising the following steps:
(a) providing a simulated infant having a housing, a head portion and neck portion each having an interior wall and an exterior wall; a simulated brain attached to said interior wall, a plurality of pressure sensors attached to said interior wall, a plurality of light indicators attached to said exterior wall and a central processing unit in communication with said pressure sensors and said indicator lights, wherein said central processing unit is operative to measure a pressure exerted upon each of said pressure sensors;
(b) holding said simulated infant, and
(c) shaking said simulated infant so that the brain engages said pressure sensors causing said indicator lights that are engaged to illuminate.

14. A shaken baby syndrome educational apparatus, comprising:
a housing having a transparent structure;
a head portion and neck portion each having an interior wall and an exterior wall;
a simulated brain attached to said interior wall.

15. The shaken baby syndrome educational apparatus of claim 14, wherein said housing has a structure similar to an infant.

16. The shaken baby syndrome educational apparatus of claim 14, wherein said housing has a structure similar to an infant.

17. The shaken baby syndrome educational apparatus of claim 14, wherein said housing is made from a pliable material at a thickness to simulate the feel of an infant's body.

18. The shaken baby syndrome educational apparatus of claim 14, wherein said housing is made from a material manufactured in human skin tones.

19. The shaken baby syndrome educational apparatus of claim 14, including a spinal cord with vertebrae attached between said brain and said interior wall.

20. The shaken baby syndrome educational apparatus of claim 14, wherein said brain is made of a gel material.
